(19) United States
(12) Patent Application Publication
(10) Pub. No.: US 2013/0223423 A1
(43) Pub. Date: Aug. 29, 2013

(54) TERMINAL AND METHOD FOR DETERMINING PRIORITY OF CONNECTION WITH A WIRELESS NETWORK ACCESS POINT

(71) Applicant: Pantech Co., Ltd., (US)

(72) Inventors: Eun Suk LEE, Seoul (KR); Young Ho LEE, Seoul (KR); Tae Hun KIM, Seoul (KR)

(73) Assignee: Pantech Co., Ltd., Seoul (KR)

(21) Appl. No.: 13/727,871

(22) Filed: Dec. 27, 2012

(30) Foreign Application Priority Data
Feb. 29, 2012 (KR) 10-2012-0021117

(51) Int. Cl. H04W 76/00

(52) U.S. Cl. CPC H04W 76/00
USPC 370/338

(57) ABSTRACT

A terminal and method for performing wireless communication to determine priority of a wireless connection to an access point (AP), including scanning APs within a receivable range of the terminal to collect air log information; one or more of classifying the APs within the receivable range according to Received Signal Strength Indication (RSSI), determining a number of terminals connected to the APs in the receivable range, or determining a number of terminals connectable to a corresponding AP for the APs in the receivable range, and determining an order of priority to connect the terminal to at least one AP within the receivable range, based the connection status of the AP, the classification according to RSSI, the number of terminals connected to the APs, or a number of terminals connectable to the APs.

### CROSS-REFERENCE TO RELATED APPLICATION

This application claims priority to Korean Patent Application No. 10-2012-0021117, filed on Feb. 29, 2012, and all the benefits accruing therefrom under 35 U.S.C. §119(a), the contents of which in its entirety are herein incorporated by reference for all purposes as if fully set forth herein.

### BACKGROUND

1. Field

Exemplary embodiments relate to a terminal and method for determining priority of connection with a wireless network access point (AP), such as a wireless fidelity (WiFi) wireless network.

2. Discussion of the Background

FIG. 1 is a diagram showing an example of attempting a connection between a terminal and an AP in the related art. Referring to FIG. 1, it is assumed that three APs (A, B and C) may search the surroundings of a terminal 10. As illustrated in FIG. 1, the maximum number of users connectable to the A AP is 5, among which 3 users are indicated as connected to the A AP. The maximum number of users connectable to the B AP is 7, among which 7 users are indicated as connected to the B AP. The maximum number of users connectable to the C AP is 10, among which 2 users are indicated as connected to the C AP. In addition, the Received Signal Strength Indication (RSSI) of the A AP is −60 dBm, the RSSI of the B AP is −30 dBm, and the RSSI of the C AP is −80 dBm, where dBm corresponds to decibel-milliwatt.

According to a related AP connection structure under the above environment of FIG. 1, a terminal 10 may attempt a connection to the B AP based on only on the RSSI without taking into consideration a number of users that may be at a same time currently connectable to a the B AP, as indicated by the arrow in FIG. 1. However, since the number of users connected at a same time to the B AP meets B AP's maximum user number of 7, the terminal 10 may fail to connect to the B AP. In addition, since the terminal 10 may not recognize the number of users connected to the B AP may be at the maximum user number that may access the B AP at a same time, the terminal 10 may attempt a connection to the B AP again. In this case, the terminal 10 performs scanning again from the beginning and thus may waste the AP scanning time. In addition, the user may be inconvenienced when attempting the wireless network, such as a WiFi, connection.

In the example illustrated in FIG. 1, an AP with the highest connection possibility is the A AP which has a high RSSI and, as indicated, can accommodate a number of connectable users at the time,

### SUMMARY

Exemplary embodiments relate to a terminal, and, as used herein, a terminal may refer to and include a terminal, a communication terminal, communication terminal apparatus, or other apparatuses and relate to methods for determining priority of connection with a wireless network, such as WiFi, Access Point (AP). And, more particularly, to a terminal, such as may include and refer to a terminal, a communication terminal, communication terminal apparatus, or other apparatuses and to methods for determining priority of an AP connection, which may allow a relatively rapid connection to an AP with a highest connection possibility taking into consideration the connection status of the AP, the number of connected terminals of an AP, the number of connectable terminals of a AP, or the RSSI of the APs within a receivable range of the terminal, such as may include or refer to a terminal, a communication terminal, a communication terminal apparatus, or other apparatuses, when the terminal, the communication terminal, the communication terminal apparatus, or other apparatus connects or attempts connection to neighboring APs.

Exemplary embodiments of the invention provide a terminal to determine priority of a wireless connection to an access point (AP), including: an AP scanning unit to scan one or more APs within a receivable range of the terminal to collect air log information of a corresponding AP for the one or more APs within the receivable range; a first AP information parsing unit to parse the collected air log information to determine a connection status of a corresponding AP for the one or more APs; and a controller to determine an order of priority to connect the terminal to the one or more APs within the receivable range based on the determined connection status of a corresponding AP for the one or more APs within the receivable range.

Exemplary embodiments of the invention also provide a terminal to determine priority of an access point (AP) connection, including: an AP scanning unit to scan one or more APs within a receivable range; a first AP information parsing unit connected to the AP scanning unit to determine if the one or more scanned APs are in a full connection status; a second AP information parsing unit connected to the AP scanning unit to classify the one or more scanned APs according to Received Signal Strength Indication (RSSI); and a controller connected to the first AP information parsing unit and the second AP information parsing unit to provide a connectable AP list containing the one or more scanned APs which are not in a full connection status arranged in an RSSI order from a higher RSSI to a lower RSSI.

Exemplary embodiments of the invention further provide a method for performing wireless communication to determine priority of a wireless connection to an access point (AP), including: scanning at least one AP within a receivable range of a terminal to collect air log information of the at least one AP; determining from the collected air log information a connection status of the at least one AP in the receivable range; and determining an order of priority to connect the terminal to the at least one AP within the receivable range, based on the determined connection status of the at least one AP.

Exemplary embodiments of the invention also provide a method for determining priority of an access point (AP) connection, including: scanning one or more APs within a receivable range; parsing AP information by determining if the one or more scanned APs are in a full connection status and classifying the one or more scanned APs according to Received Signal Strength Indication (RSSI); and determining a priority of connectable APs of the one or more scanned APs, which are not in a full connection status, based at least in part on an AP having a higher RSSI based on the parsed AP information.

Additional features of the invention will be set forth in the description which follows, and in part will be apparent from the description, or may be learned by practice of the invention.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram showing an example of attempting a connection between a terminal and an AP in the related art;

FIG. 2 is a block diagram showing a terminal to determine priority of a wireless network AP connection according to exemplary embodiments of the present invention.

FIG. 3, FIG. 4 and FIG. 5 are illustrations of air log information for checking the connection of an AP within a receivable range and the number of connected terminals according to exemplary embodiments of the present invention.

FIG. 6 illustrates air log information containing a deauthentication message according to exemplary embodiments of the present invention.

FIG. 7 is a flowchart illustrating a process of classifying priority of APs based on RSSI according to exemplary embodiments of the present invention.

FIG. 8 is a flowchart illustrating a method for determining priority of a wireless network AP connection according to exemplary embodiments of the present invention.

FIG. 9 is a block diagram showing a terminal for determining priority of a wireless network AP connection according to exemplary embodiments of the present invention.

FIG. 10 is a flowchart illustrating a process of determining the maximum number of connectable terminals to each AP according to exemplary embodiments of the present invention.

FIG. 11 illustrates air log information which is parsed according to exemplary embodiments of the present invention.

FIG. 12 is a flowchart illustrating a method for determining priority of a wireless network, such as WiFi, AP connection according to exemplary embodiments of the present invention.

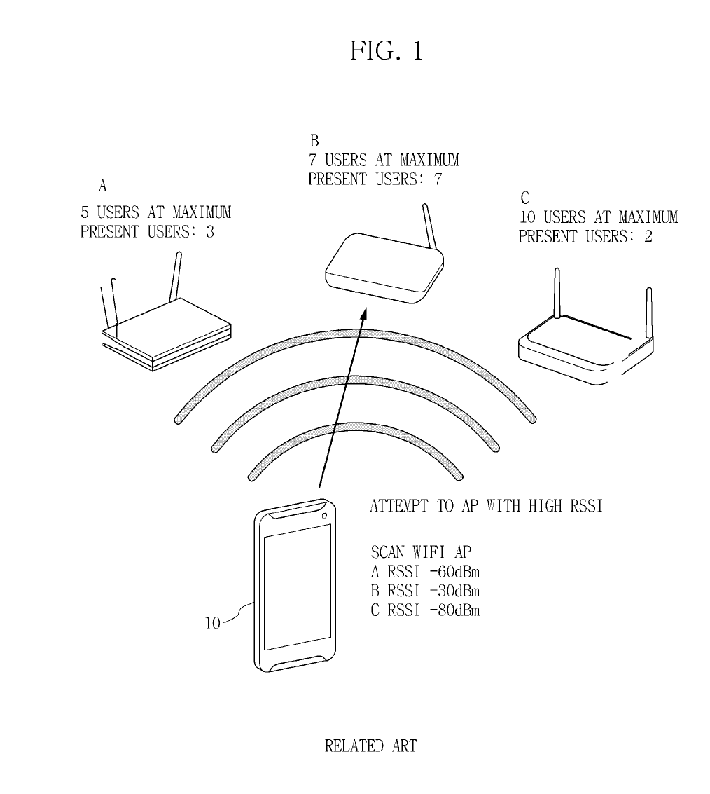

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

As used throughout a wireless network may include wireless fidelity (WiFi), a wireless broadband (WiBro), and the like, and accordingly should not be construed in a limiting sense or as being limited to a specific scheme.

It will be understood that when an element is referred to as being “connected to” another element, it can be directly connected to the other element, or intervening elements may be present; and, as to wireless communication, may be interpreted as being wirelessly connected, such as a wireless connection between a terminal and an access point (AP).

Hereinafter, a terminal as may refer to or include a terminal, a communication terminal apparatus, a communication terminal, or other apparatuses, such as including, for example, handheld, portable or tablet computer or communication devices, and methods for performing wireless communication to determine priority of a wireless connection to an access point will be described in more detail with reference to the drawings. And an access point (AP) as used herein may include, for example, any of various devices or structures used as APs for wireless communication, such as a hub, network hub, Ethernet hub or router, or the like, and may include hardware, firmware, or software to perform various functions of an access point, including those described herein, as may be known to one of skill in the art.

Hereinafter, a terminal, as may include or refer to a terminal, a communication terminal apparatus, communication terminal, or other apparatuses, such as, including, for example, handheld, portable or tablet computer or communication devices, and methods for determining priority of a wireless connection to an AP will be described in more detail with reference to the drawings.

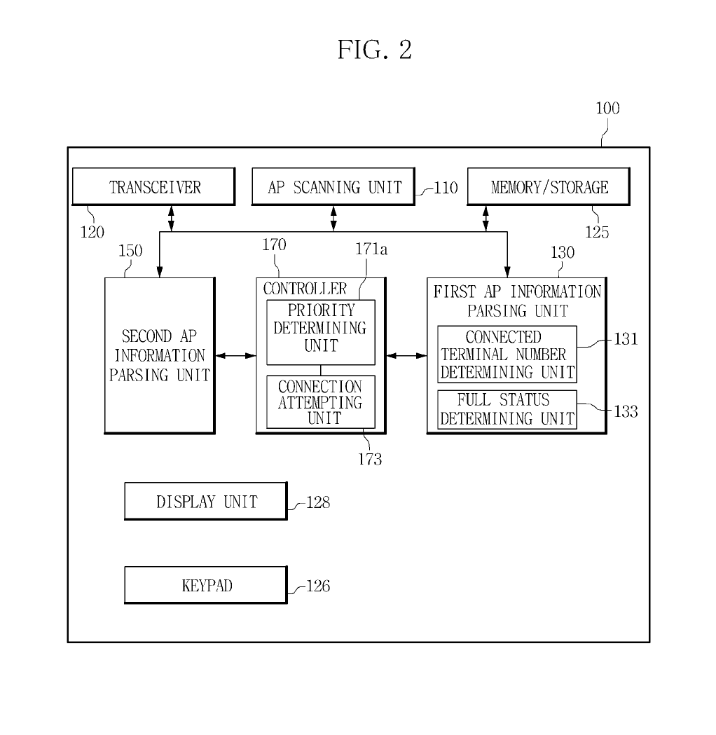

FIG. 2 is a block diagram showing a terminal to determine priority of a wireless network AP connection according to exemplary embodiments of the present invention.

FIG. 2 is a block diagram showing a terminal 100 for determining priority of a wireless network AP connection, such as a WiFi AP connection, according to exemplary embodiments. Referring to FIG. 2, the terminal 100 for determining priority of a wireless network AP connection according to exemplary embodiments includes an AP scanning unit 110, a first AP information parsing unit 130, a second AP information parsing unit 150, and a controller 170. In addition, the first AP information parsing unit 130 includes a connected terminal number determining unit 131 and a full status determining unit 133, and the controller 170 includes a priority determining unit 171a and a connection attempting unit 173.

The terminal 100 may also include a transceiver 120 to transmit and receive data signals or voice signals to or from the terminal 100, such as requesting and receiving air log information. Also the communication and control apparatus 100 may include a memory/storage 125 to store software programs, program instructions, data files, data structures, or the like. The terminal may also include a display unit 128 to display and/or enter information, such as information related to determining priority of a wireless connection to an access point and may include a keypad 126, or other entry device, to enter information or perform selection or commands for the terminal 100.

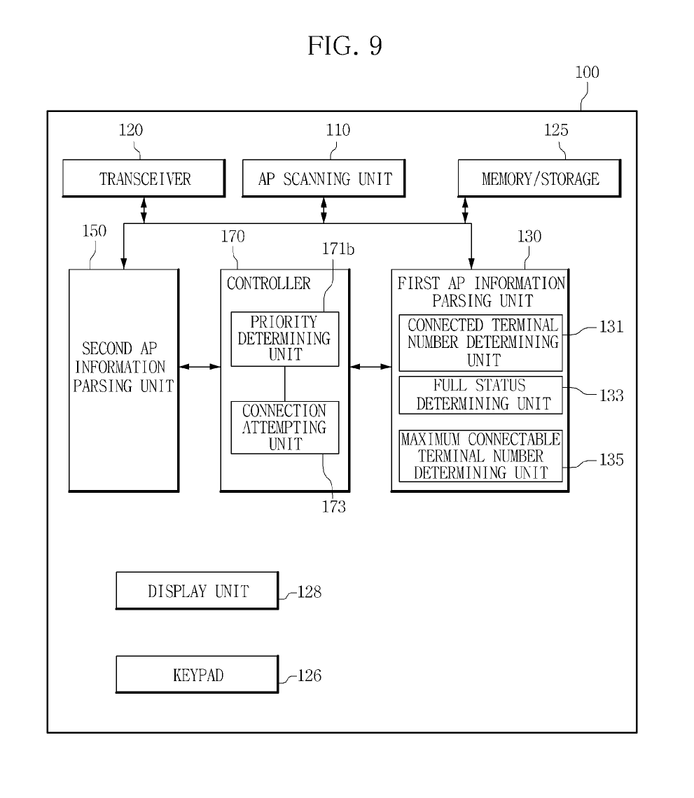

The communication control apparatus 100, including the AP scanning unit 110, the first AP information parsing unit 130, the second AP information parsing unit 150, the controller 170, the connected terminal number determining unit 131, and the full status determining unit 133, the priority determining unit 171a, the connection attempting unit 173, and the memory/storage 125, as well as a priority determining unit 171b and a maximum connectable terminal number determining unit 135 to be discussed included in FIG. 9, may include any of various memory or storage media for storing software, program instructions, data files, data structures, and the like, and may also include any of various processors, computers or application specific integrated circuits (ASICs) for example, to implement various operations in cancelling, reducing or minimizing generated noise or noise signals, as described herein.

The software, media and program instructions may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described embodiments of the present invention.

The AP scanning unit 110 may be connected to the first AP information parsing unit 130 and the second AP information parsing unit 150, and the AP scanning unit 110 may scan one or more APs within a receivable range of the terminal 100 and may collect air log information of one or more corresponding APs within a receivable range of the terminal 100. The air log information may include information about signals communicated among neighboring APs as, for example, connection requests/responses between neighboring APs and surrounding terminals, authentication/deauthentication messages, and RSSIs. The air log information collected by the AP scanning unit 110 may be transmitted to the first AP information parsing unit 130 and the second AP information parsing unit 150.

The first AP information parsing unit 130 may parse the air log information collected by the AP scanning unit 110 and may determine the number of terminals connected to an AP and the number of terminals connectable to the corresponding AP, namely the first AP information parsing unit 130 may determine whether the AP is in a full connection status. The first AP parsing unit 130 therefore may determine one or more of the connection status of a corresponding AP in the receivable range of the terminal 100, a number of terminals connected to a corresponding AP of the one or more APs in the receivable range of the terminal 100, or may determine a number of terminals connectable to a corresponding AP point of one or more APs in the receivable range of the terminal 100.

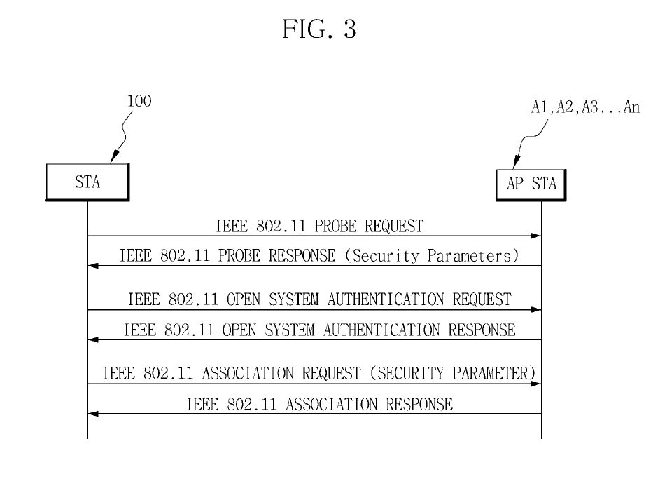

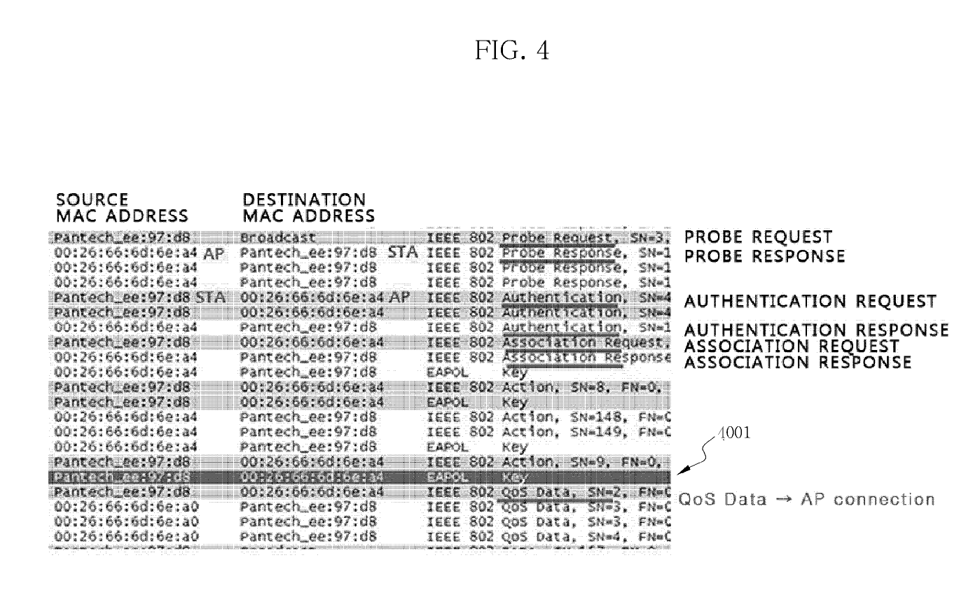

The connected terminal number determining unit 131 may be configured to parse the air log information collected by the AP scanning unit 110 and may determine the number of terminals connected to each AP within a receivable range of the terminal 100, such as to determine one or more of a number of terminals connected to a corresponding AP. A method for determining the number of connected terminals to an AP, according to exemplary embodiments, will be described with reference to FIG. 3, FIG. 4 and FIG. 5.

FIG. 3, FIG. 4 and FIG. 5 are illustrations of air log information for checking the connection of an AP within a receivable range and the number of connected terminals according to exemplary embodiments of the present invention.

As shown in FIG. 3, in order to make a connection between a terminal 100 (also referred to as STA in FIG. 3) and an access point AP (also referred to as AP STA in FIG. 3), such as access points A1, A2, A3 . . . An, within a receivable range of terminal 100, a probe request and response, an authentication request and response, and an association request and response may be performed. The probe request represents sending signals to the surroundings of the terminal 100 in order to search neighboring APs within a receivable range of the terminal 100, and the probe response is a confirmation response sent by a searched AP with respect to the probe request. The open system authentication request is a request for authentication, sent by the terminal 100 to the AP. This request may be made without the presence of a password of the AP, and if there is a password, the request may be made together with a password of the AP. The association request represents a request for connecting to the AP, such as where the authenticated terminal 100 may receive permission from the AP. The association response represents that the AP may allow an association to the authenticated terminal 100 so that the terminal 100 may use a wireless network, such as WiFi, for example.

In other words, the terminal 100 may send a probe request, an open system authentication request and an association request to the AP in that order, and the AP may respond to each request. After that, a connection may be made between the terminal 100 and the AP. If the terminal 100 and the AP are connected as described above, a Quality of Service (QoS) data packet may be transmitted from the AP to the terminal 100. The QoS data indicates a capability to determine priority of another application program, user or data stream or ensuring the data transmission performance to a specific level, for example.

Referring to FIG. 4, in a source Media Access Control (MAC) address, Pantech_ee:97:d8 represents a MAC address of the AP, and in a destination MAC address, 00:26:66:6d:6e:a4 represents a MAC address of the terminal. The MAC address may represent a physical address of Ethernet which is a network model used in a local area network (LAN) that is an information communication network within a specific area. In other words, each AP and terminal, such as terminal 100, may be distinguished by using the MAC address. FIG. 4 shows transmission of a probe request/response, an open system authentication request/response and an association request/response between an AP having a MAC address of Pantech_ee:97:d8 and a terminal having a MAC address of 00:26:66:6d:6e:a4, for example.

The portion 4001 of FIG. 4 shows QoS data transmission between a terminal having a MAC address of Pantech_ee:97:d8 and an AP having a MAC address of 00:26:66:6d:6e:a4. Therefore, a terminal, such as terminal 100, which is attempting a connection may recognize that the terminal having a MAC address of Pantech_ee:97:d8 and an AP having a MAC address of 00:26:66:6d:6e:a4 are presently communicating with each other.

In addition, a method for determining the number of terminals connected to each AP will be described with reference to FIG. 5 according to exemplary embodiments of the present invention.

Referring to FIG. 5, three source MAC addresses and three destination MAC addresses are present, and they all display QoS data packets. In this case, even though three source MAC addresses are 00:26:66:6d:6e:a0 and are identical to each other, three destination MAC addresses are different from each other. This represents that three terminals are connected to a single AP. In other words, the number of terminals connected to an AP may be identical to the number of different destination MAC addresses connected to the source MAC address that transmits the QoS data packets.

Continuing with reference to FIG. 5 and also to FIG. 2, the connected terminal number determining unit 131 may determine the number of terminals connected to each AP, such as to determine one or more of a number of terminals connected to a corresponding AP, such as by parsing the air log information as described above, and transmits the information to the controller 170.

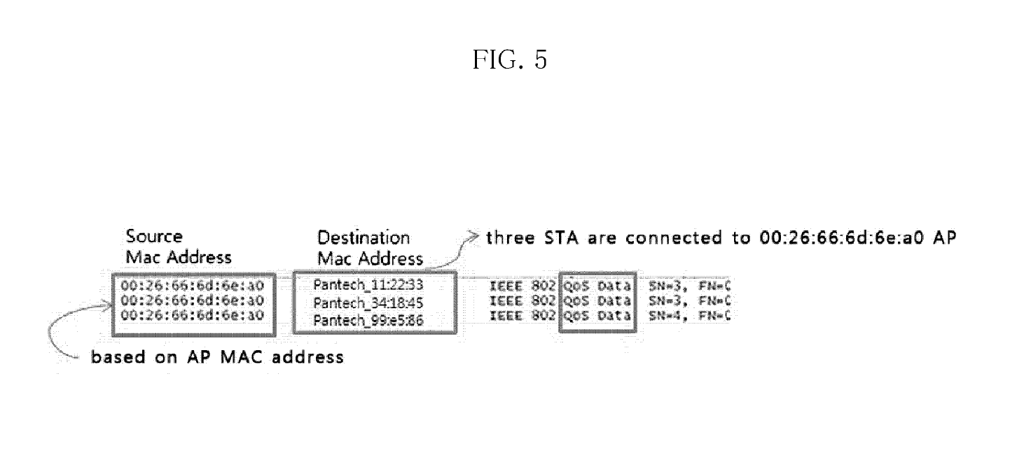

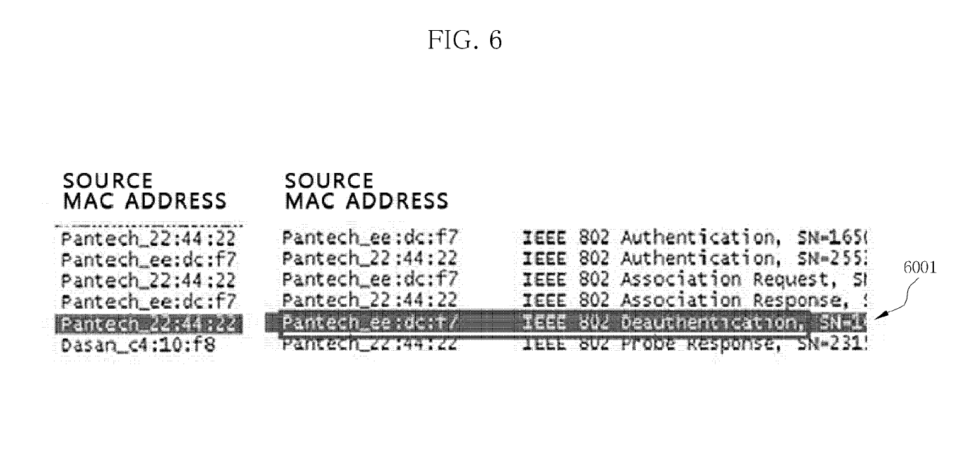

The full status determining unit 133 may determine whether terminals are fully connected to the corresponding AP, such as by determining a number of terminals connected to a corresponding AP of one or more APs in the receivable range and by determining a corresponding AP in one of a full connection status or not in a full connection status. And the full status determining unit 133 may transmit the information about the number of connected terminals and the full connection status to the controller 170. It may be determined whether terminals are fully connected to the AP by checking whether the log information contains a deauthentication message. The deauthentication message will be described further with reference to FIG. 6 according to exemplary embodiments.

Referring to FIG. 6, a deauthentication message 6001 may be transmitted from the MAC address of Pantech_{—}22:44:22 to the destination address of Pantech_ee:dc:f/. This deauthentication message 6001 indicates that the terminal having a destination address of Pantech_ee:dc:f/ has attempted a connection to an AP having a MAC address of

Pantech_{—}22:44:22, and the AP has not authenticated the connection attempt of the terminal. In other words, the presence of the deauthentication message 6001 indicates that the number of terminals connected to the corresponding AP is saturated, e.g. at a full connection status. Therefore, the full status determining unit 133 may determine the full connection status according to the presence of the deauthentication message for each AP and may transmit the information to the controller 170.

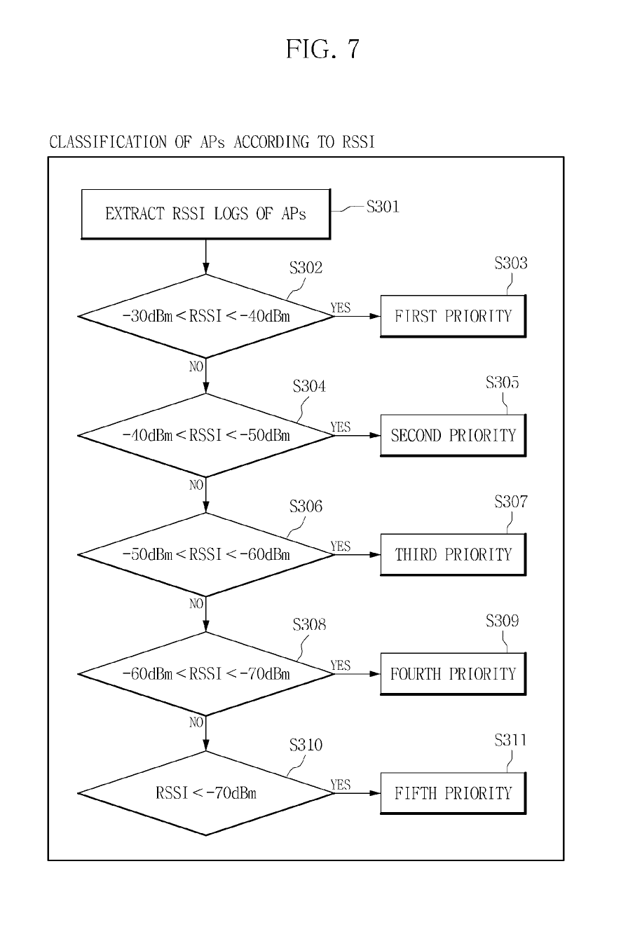

The second AP information parsing unit 150 may be connected to the AP scanning unit 110 and the controller 170 and may be configured to classify the air log information collected by the AP scanning unit 110 according to RSSI. The second AP information parsing unit 150 may therefore parse the collected air log information to classify according to RSSI one or more APs within the receivable range of the terminal 100. The process for the second AP information parsing unit 150 to classify APs according to RSSI will be described in more detail with reference to FIG. 7 according to exemplary embodiments.

FIG. 7 is a flowchart for illustrating a process of classifying priority of APs based on RSSI according to exemplary embodiments of the present invention.

Referring to FIG. 7, the second AP information parsing unit 150 may extract an RSSI log from the air log information collected by the AP scanning unit 110 (S301). After that, the second AP information parsing unit 150 may classify the extracted RSSI air logs according to an RSSI range belonging to a predetermined or reference size. For example, as shown in FIG. 7, the second AP information parsing unit 150 may determine whether RSSI of the AP is in the range of about −30 dBm<RSSI<−40 dBm (S302). In a case where RSSI of the AP is in the range of about −30 dBm<RSSI<−40 dBm, this AP may be classified into a first priority (S303). In addition, if the RSSI of the AP is not in the range of about '30 dBm<RSSI<−40 dBm, the second AP information parsing unit 150 may determine whether RSSI of the AP is in the range of about −40 dBm<RSSI<−50 Bm (S304). If RSSI of the AP is in the range of about −40 dBm<RSSI<−50 dBm, this AP may be classified into a second priority (S305). If not, the process proceeds to operation S306.

At operation S306, the second AP information parsing unit 150 may determine whether the RSSI of the AP is in the range of about −50 dBm<RSSI<−60 dBm (S306) and, if so, this AP may be classified into a third priority (S307). If not, the process proceeds to operation S308. At operation S308, the second AP information parsing unit 150 may determine whether the RSSI of the AP is in the range of about −60 dBm<RSSI<−70 dBm (S308) and, if so, this AP may be classified into a fourth priority (S309). If not, the process proceeds to operation S310. At operation S310 the second AP information parsing unit 150 may determine whether the RSSI of the AP is less than about RSSI<−70 dBm (S310) and, if so, this AP may be classified into a fifth priority (S311). And, the process then proceeds to return to operation S301 for a next AP to be classified. If no other AP within the receivable range of the terminal 100 remains to be classified, the process proceeds to End.

As described above, the second AP information parsing unit 150 may classify an AP into a lower priority as the RSSI has a wider range. However, even though according to exemplary embodiments, the second AP information parsing unit 150 may classify APs into five priorities, the number of priorities or the range of the RSSI corresponding to each priority may be changed for user convenience or in relation to use or application, for example. The second AP information parsing unit 150 may provide the information about the classified APs to the controller 170.

The priority determining unit 171a of the controller 170 may determine the priority of AP to be connected with the terminal 100, such as by using the information transmitted from the first AP information parsing unit 130 and the second AP information parsing unit 150, for example.

For example, the priority determining unit 171a may exclude an AP in a full connection status (containing a deauthentication message), among the APs received from the second AP information parsing unit 150. Therefore, priority of APs which may not be in a full connection status and, therefore, may have room for a further or additional connection, may be firstly determined according to RSSI. For example, priority of APs which may not be in a full connection status and have a first-priority RSSI may be firstly determined, and then priority of APs which are not in a full connection status and have a second-priority RSSI may be determined.

The priority of an AP for connection may be determined as follows, for example:

1. AP not in a full connection status (namely, an AP may have room for a further or additional connection); and

2. AP having a higher RSSI.

According to exemplary embodiments, the priority determining unit 171a may also determine priority of APs which may not be in a full connection status but have a RSSI of the same priority, from an AP having a smaller number of connected terminals. For example, for APs not in a full connection status and having a RSSI of the first priority, priority may be assigned to an AP having a smaller number of connected terminals, and then, for APs not in a full connection status and having a RSSI of the second priority, priority may be assigned to an AP having a smaller number of connected terminals.

The priority may also be determined as follows, for example:

1. AP not in a full connection status (namely, an AP may have room for a further or additional connection);

2. AP having a higher RSSI; and

3. AP having a smaller number of connected terminals.

In other words, in any case, an AP in a full connection status (containing a deauthentication message) may be firstly excluded, and the priority may be determined from an AP having higher a RSSI or from an AP having a higher RSSI and having a smaller number of connected terminals.

For example, the controller 170, such as by the priority determining unit 171a, may determine an order of priority to connect the terminal 100 to one or more APs within the receivable range by assigning a priority based on one or more of: a determination of APs in the receivable range not in a full connection status, and on a high RSSI in a relative order to a low RSSI of the APs; or a determination of APs in the receivable range not in a full connection status, on a high RSSI in a relative order to a low RSSI of the APs, and on APs in a relative order of a smaller number to a larger number of connected terminals.

And the controller 170 may determine an order of priority of connectable APs, such as a connectable APs list, for example, to connect the terminal 100 to one or more APs within the receivable range of the terminal 100, based upon one or more of the classification of one or more APs according to RSSI, and the number of terminals connected to the one or more APs; or, as discussed with respect to the exemplary embodiments illustrated in FIG. 9, a number of terminals connectable to a corresponding AP.

Therefore, priority of connection to an AP by the terminal 100 may be based on, for example, a connection status of an AP, such as whether the AP in a full connection status or not in a full connection status. Also, priority of connection to an AP by the terminal 100 may be based on, in addition to the connection status of a corresponding AP, for example, a number of terminals connected to a corresponding AP, or the RSSI of a corresponding AP, or any one or more or combination thereof, and should not be construed in a limiting sense.

After the priority for attempting a connection for all APs scanned by the AP scanning unit 110 may be determined as described above, the connection attempting unit 173 may attempt a wireless network, such as WiFi, connection according to the priority determined by the priority determining unit 171a. Therefore, the controller 170, such as by the connection attempting unit 173, may attempt connection with one or more APs within the receivable range of the terminal 100 based on the determined order of priority.

In detail, in case of attempting a connection to an AP having the highest priority and succeeding in the connection, the connection attempting unit 173 may maintain the wireless network, such as WiFi, connection. If the attempt fails, the connection attempting unit 173 may repeat attempting a connection to an AP of next priority until the connection to an AP succeeds. As a result, the terminal 100 may attempt a connection to APs from an AP which has highest RSSI, is not in a full connection state and has a smallest number of connected terminals, for example.

The connection attempting unit 173 may attempt a connection automatically or manually by means of user selection such as by using the keypad 126 or by entering information on a touch screen of a display unit 128 of terminal 100. In addition, the controller 170 may display APs according to the priority on the display unit 128 of the terminal 100. And the display unit 128 may therefore display the determined order of priority of one or more APs in the receivable range of the terminal 100 to attempt wireless connection with one or more of the APs. The user may attempt a connection to an AP of the highest priority with reference to the displayed priority of APs or may attempt a connection to an AP of appropriate priority according to user selection. The display unit 128 therefore may indicate a selection of or enable a selection of at least one AP for wireless communication of the terminal 100 with a selected AP.

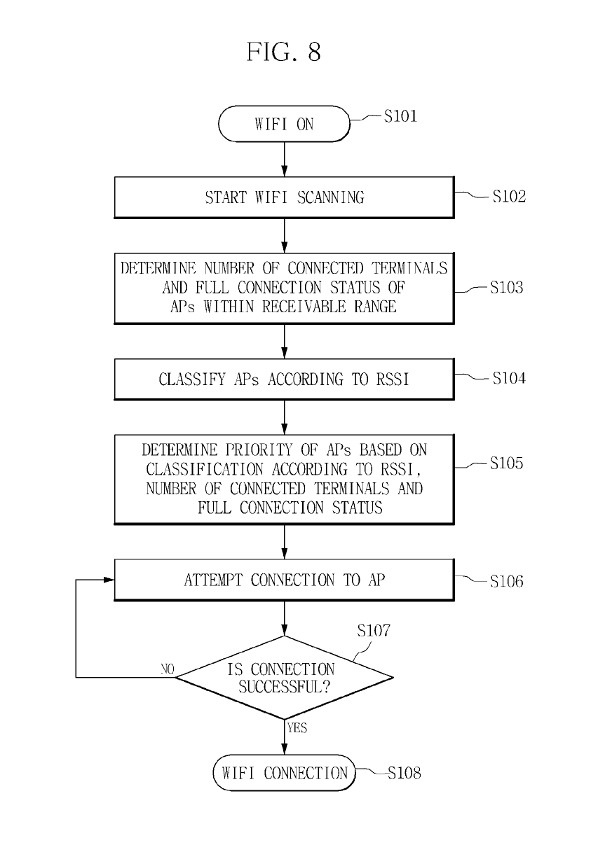

Hereinafter, a method for determining priority of wireless network, such as WiFi, AP connection according to exemplary embodiments will be described, with reference to FIG. 8.

FIG. 8 is a flowchart for illustrating the method for determining priority of a wireless network AP connection according to exemplary embodiments of the present invention.

Referring to FIG. 8, where the terminal 100 turns on a wireless network, such as a WiFi network, (S101), the AP scanning unit 110 may scan one or more APs around the terminal 100 and may collect air log information of the one or more APs within a receivable range of the terminal 100 (S102).

The connected terminal number determining unit 131 of the first AP information parsing unit 130 may then determine the number of terminals connected to each AP, and the full status determining unit 133 may determine whether the number of terminals connected to each AP is at or corresponds to a saturation number, i.e. a number corresponding to full connection status, for the corresponding AP, (S103). The process of S103 according to exemplary embodiments is, for example, as described in detail with reference to FIG. 3, FIG. 4, FIG. 5 and FIG. 6.

After S103, the second AP information parsing unit 150 may classify APs according to RSSI (S104). A process for the second AP information parsing unit 150 to classify APs according to RSSI has been described above with reference to FIG. 7 according to exemplary embodiments.

The priority determining unit 171a of the controller 170 may then determine priority of APs to be connected, based on the classification according to RSSI, the number of connected terminals and the full connection status (S105), for example. In other words, APs in a full connection status (containing a deauthentication message) may be firstly excluded, and then the priority may be determined from an AP having higher a RSSI, or the priority may be determined from an AP having a higher RSSI and having a smaller number of connected terminals, for example.

Finally, the connection attempting unit 173 may attempt a connection to APs according to the priority determined by the priority determining unit 171a (S106). As described above, the connection attempting unit 173 may attempt a connection automatically or manually, such as, by user selection, for example.

After that, the connection attempting unit 173 may determine whether the attempted connection to an AP is successful (S107). If the connection is successful, the connection attempting unit 173 may maintain the wireless network, such as WiFi, connection and may stop further attempt for a connection (S108). However, if the connection fails, the process returns to S106, and the connection attempting unit 173 may then attempt a connection to an AP which has the next priority of the above described determined AP priority order, for example.

FIG. 9 is a block diagram illustrating a terminal 100 for determining priority of a wireless connection to an AP in a wireless network, such as WiFi, according to exemplary embodiments of the present invention.

Referring to FIG. 9, the terminal 100 for determining priority of a wireless network AP connection, such as a WiFi network, according to exemplary embodiments includes the AP scanning unit 110, the first AP information parsing unit 130, the second AP information parsing unit 150, and the controller 170. In addition, the first AP information parsing unit 130 includes the connected terminal number determining unit 131, the full status determining unit 133 and a maximum connectable terminal number determining unit 135, and the controller 170 includes a priority determining unit 171b and the connection attempting unit 173, for example.

Therefore, the terminal 100 illustrated in FIG. 9, according to exemplary embodiments, also includes the maximum connectable terminal number determining unit 135; and, additionally, the priority determining unit 171b of the controller 170 may determine priority in consideration of the number of connectable terminals as well as the classification according to RSSI, the full connection status and the number of connected terminals, for example.

In other words, according to exemplary embodiments previously discussed with respect to the terminal 100 illustrated in FIG. 2, when determining priority one or more APs in a full connection status (containing a deauthentication message) may be firstly excluded, and then the priority may be determined from an AP having a higher RSSI, or the priority may be determined from an AP having a higher RSSI and having a smaller number of connected terminals, for example.

However, according to exemplary embodiments with respect to the terminal 100 illustrated in FIG. 9, the number of connectable terminals may be added to the previously described criteria to determine an order of priority to connect the terminal 100 to the APs, discussed in relation to the terminal 100 illustrated in FIG. 2.

Therefore, one or more APs in a full connection status (containing a deauthentication message) may be firstly removed, and then the priority may be determined from an AP having a higher RSSI and having a greater number of connectable terminals, or the priority may be determined from an AP having a higher RSSI and having a smaller number of connected terminals and a greater number of connectable terminals, for example. And the terminal 100 as illustrated in FIG. 9 attempting a connection according to such priority criteria may further improve a connection possibility to an AP.

Among the components of the exemplary embodiments in relation to the terminal 100 illustrated in FIG. 9, the AP scanning unit 110, the connected terminal number determining unit 131, the full status determining unit 133, and the second AP information parsing unit 150 are similar to corresponding components previously discussed in relation to exemplary embodiments of the terminal 100 illustrated in relation to FIG. 2; and, as such, may not be described in further detail as to exemplary embodiments in relation to FIG. 9.

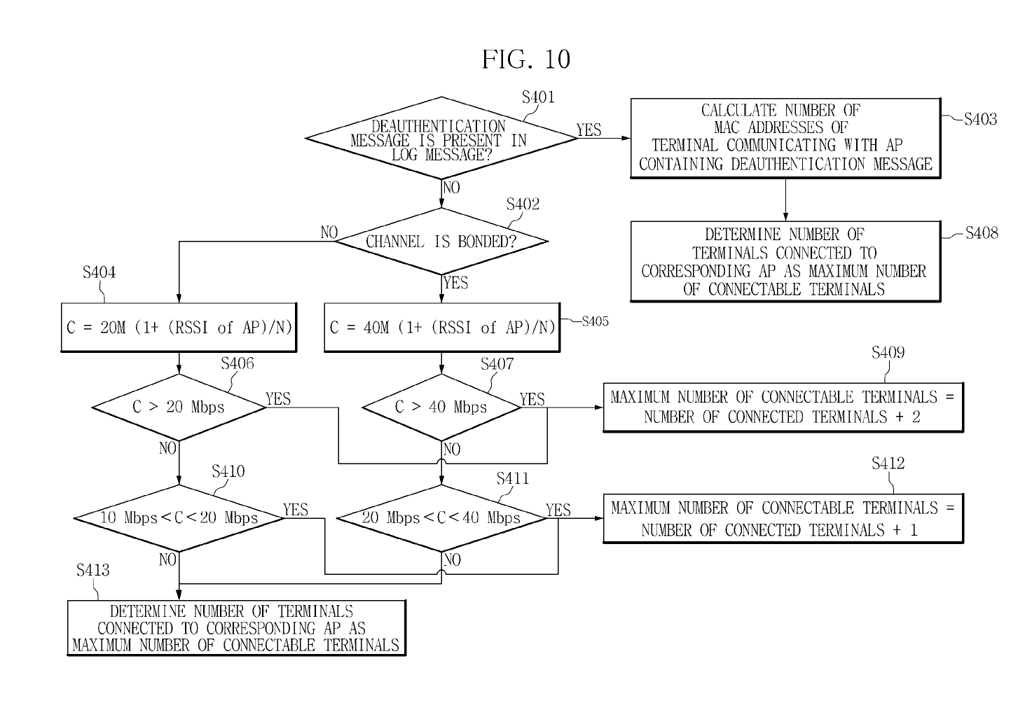

Referring to FIG. 9, the maximum connectable terminal number determining unit 135 may parse the air log information received from the AP scanning unit 110 and may determine the maximum number of terminals connectable to each AP. The maximum connectable terminal number determining unit 135 may therefore determine a maximum number of connectable terminals of a corresponding AP of one or more APs within the receivable range of the terminal 100. The process for the maximum connectable terminal number determining unit 135 to determine the maximum number of terminals connectable to each AP will be described in detail as follows with reference to FIG. 10 according to exemplary embodiments.

FIG. 10 is a flowchart for illustrating a process of determining the maximum number of terminals connectable to each AP according to exemplary embodiments of the present invention.

Referring to FIG. 10, the terminal 100 may determine whether a deauthentication message is present in the air log information of the AP (S401). And the maximum connectable terminal number determining unit 135 may obtain the information about the presence of the deauthentication message from the full status determining unit 133 and may obtain the information about the number of connected terminals from the connected terminal number determining unit 131.

Where a deauthentication message is present, the maximum connectable terminal number determining unit 135 may calculate or determine the number of MAC addresses of a terminal which is communicating with the corresponding AP (S403). The calculated or determined number of MAC addresses of the terminal may be the number of terminals presently connected to the corresponding AP, and the number of terminals presently connected to the corresponding AP may be equal to the maximum number of terminals connectable to the corresponding AP. This is because, if a deauthentication message is present in the log information, the corresponding AP may be already in a full connection status and does not authenticate further connection. Therefore, the maximum connectable terminal number determining unit 135 may determine the number of terminals presently connected to the corresponding AP as the maximum number of terminals connectable to the corresponding AP (S408). A method for calculating or determining the number of terminals connected to an AP has been described previously with reference to FIG. 5, according to exemplary embodiments, for example.

However, where the maximum connectable terminal number determining unit 135 may determine that a deauthentication message is not present in the air log information in S401, the process proceeds to S402. In S402, the maximum connectable terminal number determining unit 135 may determine whether a communication channel of the AP is a bonded channel.

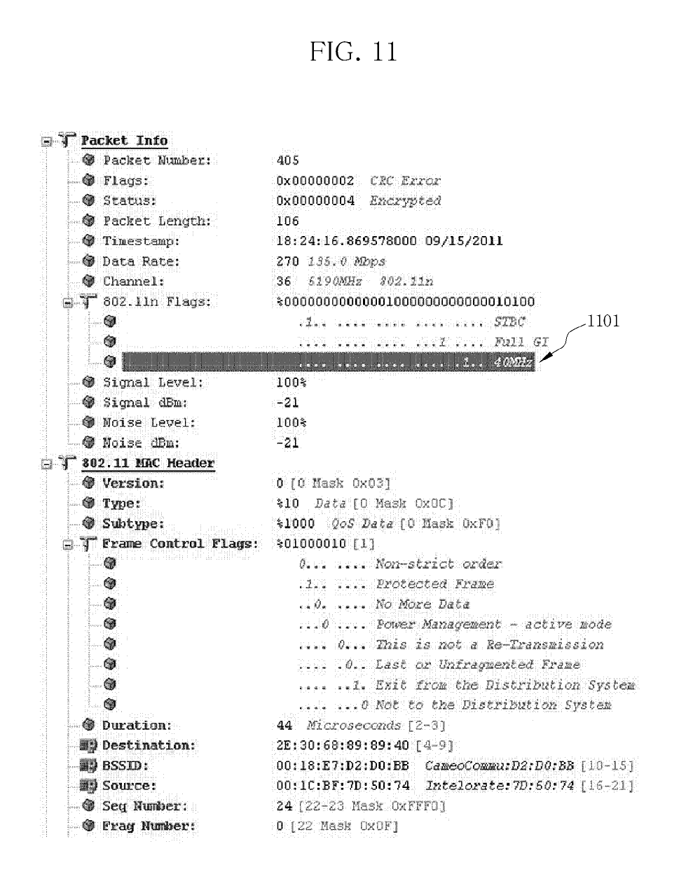

FIG. 11 illustrates a log for checking channel bonding according to exemplary embodiments of the present invention.

FIG. 11 shows air log information which is parsed according to exemplary embodiments. In FIG. 11, 40 MHz is indicated by the region 1101, which represents that the channel is a bonded channel. Where a channel is a bonded channel, 40 MHz channel capacity may be calculated or determined (S405) by the maximum connectable terminal number determining unit 135; and, if not a bonded channel, i.e. a channel other than a bonded channel, 20 MHz channel capacity may be calculated or determined (S404) by the maximum connectable terminal number determining unit 135. In S405, the terminal may calculate or determine 40 MHz channel capacity by using the relation C=40M (1+(RSSI of the AP)/N),

in which C=W log₂ (1+S/N),

C is a channel capacity in bits per second (bps),

W is a bandwidth,

S is a signal power of the AP,

N is a noise power, and

M=1,000 (e.g. 40M=40,000).

The maximum connectable terminal number determining unit 135 may calculate or determine AP signal power and noise power by using the parsed log shown in FIG. 11. In addition, in a general channel environment, 0<S/N<30, for example. In S407, the maximum connectable terminal number determining unit 135 may determine whether the channel capacity (C) calculated or determined in S405 is greater than about C>40 Mbps (Mbps corresponds to megabits per second). If the channel capacity C satisfies the condition of C being greater than about C>40 Mbps, the channel environment may be determined as being excellent, and the maximum number of terminals connectable to the corresponding AP may be determined as being equal to the number of connected terminals+2 (S409). In addition, if the condition channel capacity may not satisfy the condition of C being greater than about C>40 Mbps, the maximum connectable terminal number determining unit 135 may determine whether the channel capacity satisfies the condition of C being in a range of about 20 Mbps<C<40 Mbps (S411).

If the channel capacity satisfies the condition of C being in a range of about 20 Mbps<C<40 Mbps, the channel environment may be determined as being normal, and the maximum number of terminals connectable to the corresponding AP may be determined as being equal to the number of connected terminals+1 (S412). In addition, if the channel capacity does not satisfy the condition of C being in a range of about 20 Mbps<C<40 Mbps, the number of terminals connected to the corresponding AP may be determined by the maximum connectable terminal number determining unit 135 as the maximum number of connectable terminals (S413).

However, in S402, where the communication channel is not a bonded channel, the maximum connectable terminal number determining unit 135 may calculate or determine 20 MHz channel capacity by using the relation C=20M (1+(RSSI of the AP)/N), where C, W, S, N, and M in the relation have the same meaning indicated in the previously described relation for calculating or determining C. In S406, the maximum connectable terminal number determining unit 135 may determine whether the channel capacity (C) calculated or determined in S404 satisfies the condition of C being greater than about C>20 Mbps. If the channel capacity satisfies the condition of C being greater than about C>20 Mbps, the channel environment may be determined as being excellent, and the maximum number of terminals connectable to the corresponding AP may be determined by the maximum connectable terminal number determining unit 135 as being equal to the number of connected terminals+2 (S409).

In addition, if the channel capacity does not satisfy the condition of C being greater than about C>20 Mbps, it may be determined by the maximum connectable terminal number determining unit 135 whether the channel capacity satisfies the condition of C being in a range of about 10 Mbps<C<20 Mbps (S410). If the channel capacity satisfies the condition of C being in a range of about 10 Mbps<C<20 Mbps, the maximum connectable terminal number determining unit 135 may determine the channel environment as being normal and may determine the maximum number of terminals connectable to the corresponding AP to be equal to the number of connected terminals+1 (S412). In addition, if the channel capacity does not satisfy the condition of C being in a range of about 10 Mbps<C<20 Mbps, the maximum number of terminals connected to the corresponding AP may be determined by the maximum connectable terminal number determining unit 135 as the maximum number of connectable terminals (S413).

Therefore, the maximum connectable terminal number determining unit 135 may determine the maximum number of connectable terminals for a corresponding AP as being one or more of: equal to a number of terminals connected to a corresponding AP, where a deauthentication message is present in the collected air log information for a corresponding AP, or equal to a number of terminals connected to a corresponding AP, where, for a bonded channel of a corresponding AP, the channel capacity (C) is less than about 20 megabits per second (Mbps) or, for a channel other than a bonded channel of a corresponding AP, the channel capacity (C) is less than about 10 Mbps, or equal to a number of terminals connected to a corresponding AP plus two, where, for a bonded channel of a corresponding AP, the channel capacity (C) is greater than about 40 Mbps or, for a channel other than a bonded channel of a corresponding AP, the channel capacity (C) is greater than about 20 Mbps, or equal to a number of terminals connected to a corresponding AP plus 1, where for a bonded channel of a corresponding AP, the channel capacity (C) is in a range of about 20 Mbps<C<40 Mbps or, for a channel other than a bonded channel of a corresponding AP, the channel capacity (C) is in a range of about 10 Mbps<C<20 Mbps.

The maximum connectable terminal number determining unit 135 may transmit information about the maximum number of connectable terminals to the controller 170.

Prior to determining the priority, the priority determining unit 171b of the controller 170 may reduce the number of connected terminals received from the connected terminal number determining unit 131, from the maximum number of connectable terminals received from the maximum connectable terminal number determining unit 135, to determine the number of terminals connectable to each AP. In other words, the number of terminals connectable to each AP may be equal to the maximum number of connectable terminals−the number of connected terminals. Therefore, the priority determining unit 171b, prior to determining priority of one or more APs in the receivable range of the terminal 100, may determine a number of the connectable terminals for a corresponding AP as a maximum number of connectable terminals minus a number of connected terminals of the corresponding AP, for example.

After that, the priority determining unit 171b may determine priority in consideration of the classification according to RSSI, the full connection status, the number of connected terminals, and the number of connectable terminals according to exemplary embodiments.

For example, the priority determining unit 171b may determine priority from an AP having a greater number of connectable terminals, excluding APs in a full connection status (containing a deauthentication message) among the APs received from the second AP information parsing unit 150. Therefore, priority of APs which are not in a full connection status and may have room for an additional connection may be determined from an AP having a higher RSSI and having a greater number of connectable terminals.

For example, for APs not in a full connection status and having a RSSI of the first priority, the priority may be determined from an AP having a greater number of connectable terminals, and next, for APs not in a full connection status and having a RSSI of the second priority, the priority may be determined from an AP having a greater number of connectable terminals.

The priority may be determined as follows, for example:

1. AP not in a full connection status (namely, the AP having room for a further or additional connection);

2. AP having a higher RSSI; and

3. AP having a greater number of connectable terminals.

In addition, the priority determining unit 171b may determine priority of APs which may be not in a full connection status but have RSSI of the same priority, from an AP having a smaller number of connected terminals and from an AP having a greater number of connectable terminals.

For example, for APs not in a full connection status and having a RSSI of the first priority, priority may be assigned to an AP having a smaller number of connected terminals and having a greater number of connectable terminals, and then, for APs not in a full connection status and having a RSSI of the second priority, priority may be assigned to an AP having a smaller number of connected terminals and having a greater number of connectable terminals.

The priority may be determined as follows, for example:

1. AP not in a full connection status (namely, an AP having room for a further or additional connection);

2. AP having a higher RSSI;

3. AP having a smaller number of connected terminals; and

4. AP having a greater number of connectable terminals.

For example, the controller 170, such as by the priority determining unit 171b, may determine an order of priority to connect the terminal 100 to one or more APs within the receivable range by assigning a priority based on one or more of: a determination of APs in the receivable range of the terminal 100 not in a full connection status, on a high RSSI in a relative order to a low RSSI of the APs, and on APs in relative order of a greater number to a smaller number of connectable terminals; or a determination of APs in the receivable range of the terminal 100 not in a full connection status, on a high RSSI in a relative order to a low RSSI of the APs, on APs in a relative order of a smaller number to a larger number of connected terminals, and on APs in relative order of a greater number to a smaller number of connectable terminals.

Therefore, priority of connection to an AP by the terminal 100 may be based on, for example, a connection status of an AP, such as whether the AP in a full connection status or not in a full connection status. Also, priority of connection to an AP by the terminal 100 may be based on, in addition to the connection status of a corresponding AP, for example, a number of terminals connected to a corresponding AP, a number of terminals connectable to a corresponding AP, or the RSSI of a corresponding AP, or any one or more or combination thereof, and should not be construed in a limiting sense.

Therefore, an AP in a full connection status (containing a deauthentication message) may be firstly excluded, and then the priority may be determined from an AP having a higher RSSI and having a greater number of connectable terminals, or from an AP having a higher RSSI and having a smaller number of connected terminals and a greater number of connectable terminals, for example.

After the priority for attempting a connection may be determined for one or more APs scanned by the AP scanning unit 110 as described above, the connection attempting unit 173 may attempt a wireless network, such as WiFi, connection according to the priority determined by the priority determining unit 171b. The connection attempt of the connection attempting unit 173 has been previously described in relation to the terminal 100 illustrated in FIG. 2 according to exemplary embodiments.

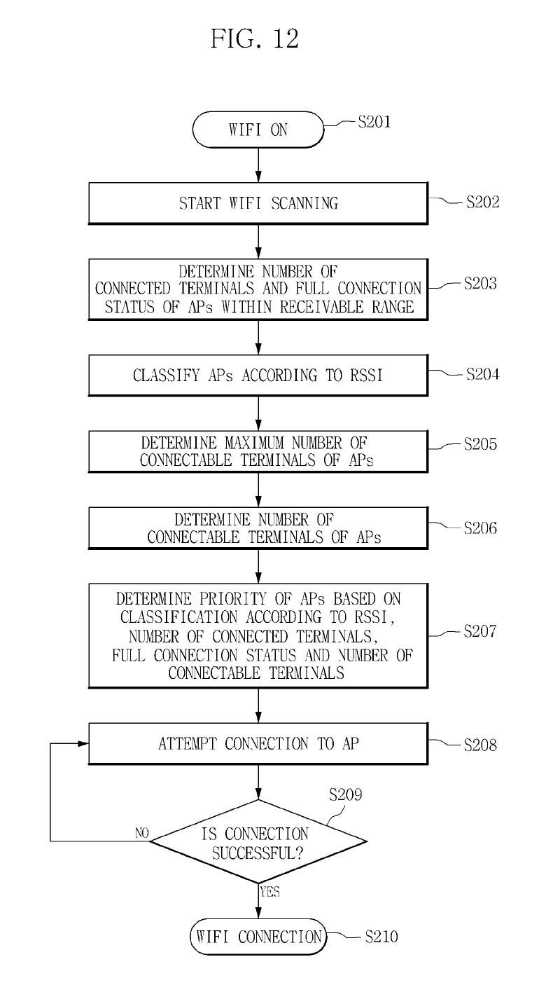

FIG. 12 is a flowchart illustrating a method for determining priority of a wireless network, such as WiFi, AP connection according to exemplary embodiments of the present invention.

Referring to FIG. 12, where the terminal 100 turns on to communicate with a wireless network, such as a WiFi network, (S201), the AP scanning unit 110 may scan one or more of APs around the terminal 100 within the receivable range of the terminal 100 and may collect air log information of the one or more APs within the receivable range (S202).

The connected terminal number determining unit 131 of the first AP information parsing unit 130 may then determine the number of terminals connected to each AP, and the full status determining unit 133 may determine whether the number of terminals connected to each AP is at a saturation number, i.e. a number corresponding to full connection status, for the corresponding AP, (S203). A process of S203 has been previously described with reference to FIG. 3, FIG. 4, FIG. 5 and FIG. 6, for example, according to exemplary embodiments.

After S203, the second AP information parsing unit 150 may classify APs according to RSSI (S204). A process for the second AP information parsing unit 150 to classify APs according to RSSI has been described previously with reference to FIG. 8, for example, according to exemplary embodiments.

The maximum connectable terminal number determining unit 135 may then determine the maximum number of terminals connectable to each AP (S205). A process of determining the maximum number of terminals connectable to each AP has been described previously with reference to FIG. 10, for example, according to exemplary embodiments.

The priority determining unit 171b may then determine the number of terminals connectable to each AP by deducting the number of connected terminals determined by the connected terminal number determining unit 131 in S203, from the maximum number of connectable terminals determined by the maximum connectable terminal number determining unit 135 in S205 (S206).

The priority determining unit 171b may then determine priority of APs to be connected, based on the full connection status, the classification according to RSSI, the number of connected terminals and the number of connectable terminals (S207). In other words, APs in a full connection status (containing a deauthentication message) are firstly excluded, and then the priority may be determined from an AP having higher a RSSI and having a greater number of connectable terminals, or the priority may be determined from an AP having a higher RSSI and having a smaller number of connected terminals and a greater number of connectable terminals, for example, according to exemplary embodiments.

Finally, the connection attempting unit 173 may attempt a connection to APs according to the priority determined by the priority determining unit 171b (S208). As previously described, the connection attempting unit 173 may attempt a connection automatically or manually, such as by user selection, for example.

The connection attempting unit 173 may then determine whether the attempted connection to an AP is successful (S209). If the connection is successful (S210), the connection attempting unit 173 may maintain the wireless network, such as WiFi, connection and may stop further attempt for a connection. However, if the connection fails, the process returns to S208, and the connection attempting unit 173 may then attempt a connection to an AP which has the next priority of the above described determined AP priority order, for example.

According to exemplary embodiments described herein, the priority of neighboring APs may be determined from an AP having room for a further or additional connection and having a higher RSSI, and the criteria or conditions about the number of connected terminals and the number of connectable terminals may be selectively used, for example.

As a result, the terminal may be connected to a connectable AP within a relatively short time where priority of a wireless connection to an AP may be determined according to exemplary embodiments of the present invention.

Moreover, according to exemplary embodiments of the present invention, when a terminal may connect to surrounding APs within the receivable range of the terminal, the terminal may be able to rapidly connect to an AP with a highest connection possibility in consideration of the number of connectable terminals as well as RSSI.

Also, the exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed:

1. A terminal to determine priority of an access point (AP) connection, the terminal comprising:
an AP scanning unit to scan one or more APs within a receivable range;
a first AP information parsing unit connected to the AP scanning unit to determine if the one or more scanned APs are in a full connection status;
a second AP information parsing unit connected to the AP scanning unit to classify the one or more scanned APs according to Received Signal Strength Indication (RSSI); and
a controller connected to the first AP information parsing unit and the second AP information parsing unit to provide a connectable AP list containing the one or more scanned APs which are not in a full connection status arranged in an RSSI order from a higher RSSI to a lower RSSI.

2. The terminal of claim 1, wherein the controller comprises:
a priority determining unit to receive from the first AP information parsing unit information indicating if the one or more scanned APs are in a full connection status, to receive from the second AP information parsing unit AP information indicating the one or more scanned APs classified according to the RSSI order, and to determine priority of connection of the one or more scanned APs, which are not in a full connection status, according to the RSSI order; and
a connection attempting unit to attempt a connection to the one or more scanned APs according to the determined priority.

3. The terminal of claim 2,
wherein the first AP information parsing unit further determines the number of terminals connected to the one or more scanned APs, and
wherein the priority determining unit receives information about the number of terminals connected to the one or more scanned APs from the first AP information parsing unit and determines priority of connection of the one or more scanned APs, which are not in a full connection status based on an AP having a higher RSSI and having a smaller number of connected terminals.

4. The terminal of claim 2,
wherein the first AP information parsing unit further determines the number of terminals connectable to the one or more scanned APs, and
wherein the priority determining unit receives information about the number of terminals connectable to the one or more scanned APs from the first AP information parsing unit and determines priority of connection of the one or more scanned APs, which are not in a full connection status based on an AP having a higher RSSI and having a greater number of terminals connectable to the AP.

5. The terminal of claim 3,
wherein the first AP information parsing unit further determines the number of terminals connectable to the one or more scanned APs, and
wherein the priority determining unit receives information about the number of terminals connectable to the one or more scanned APs from the first AP information parsing unit and determines priority of connection of the one or more scanned APs, which are not in a full connection status based on an AP having a higher RSSI, having a smaller number of connected terminals and having a greater number of connectable terminals.

6. The terminal of claim 1,
wherein the first AP information parsing unit parses air log information of the one or more scanned APs and determines an AP having a deauthentication message as the AP in a full connection status.

7. The terminal of claim 3,
wherein the first AP information parsing unit parses air log information of the one or more scanned APs and determines the number of destination Media Access Control (MAC) addresses based on the source MAC address of the AP which transmits a Quality of Service (QoS) data packet, thereby determining the number of connected terminals.

8. A terminal to determine priority of a wireless connection to an access point (AP), the apparatus comprising:
an AP scanning unit to scan one or more APs within a receivable range of the terminal to collect air log information of a corresponding AP for the one or more APs within the receivable range;
a first AP information parsing unit to parse the collected air log information to determine a connection status of a corresponding AP for the one or more APs; and
a controller to determine an order of priority to connect the terminal to the one or more APs within the receivable range based on the determined connection status of a corresponding AP for the one or more APs within the receivable range.

9. The terminal of claim 8, further comprising:
a second AP information parsing unit to parse the collected air log information to classify according to Received Signal Strength Indication (RSSI) the one or more APs within the receivable range, wherein the collected air log information comprises the RSSI, and
wherein the controller determines the order of priority to connect the terminal to the one or more APs within the receivable range by assigning a priority based on a determination of APs in the receivable range not in a full connection status and in a relative order of a high RSSI to a low RSSI of the APs.

10. The terminal of claim 8, wherein
the first AP information parsing unit parses the collected air log information to further determine a number of terminals connected to a corresponding AP for the one or more APs, and
the controller determines the order of priority to connect the terminal to the one or more APs within the receivable range further based on the determined number of terminals connected to a corresponding AP for the one or more APs.

11. The terminal of claim 8, wherein
the first AP information parsing unit parses the collected air log information to further determine a number of terminals connectable to a corresponding AP for the one or more APs in the receivable range, and
the controller determines the order of priority to connect the terminal to the one or more APs within the receivable range further based on the number of terminals connectable to a corresponding AP for the one or more APs.

12. The terminal of claim 8, further comprising:
a maximum connectable terminal number determining unit to determine a maximum number of connectable terminals of a corresponding AP for the one or more APs within the receivable range,
wherein the maximum connectable terminal number determining unit determines, where a deauthentication message corresponding to a full connection status is absent in the collected air log information for a corresponding AP, the maximum number of connectable terminals for a corresponding AP based on a channel capacity of a communication channel of a corresponding AP.

13. The terminal of claim 8, wherein
the controller comprises a priority determining unit to determine the order of priority to connect the terminal to the one or more APs in the receivable range, and
the priority determining unit, prior to determining priority of the one or more APs in the receivable range, determines a number of connectable terminals of a corresponding AP for the one or more APs as a maximum number of connectable terminals minus a number of connected terminals of a corresponding AP.

14. The terminal of claim 8, wherein the controller further comprises:
a priority determining unit to determine the order of priority to connect the terminal to the one or more APs within the receivable range, and
a connection attempting unit to attempt connection with the one or more APs within the receivable range based on the determined order of priority.

15. A method for determining priority of an access point (AP) connection, the method comprising:
scanning one or more APs within a receivable range;
parsing AP information by determining if the one or more scanned APs are in a full connection status and classifying the one or more scanned APs according to Received Signal Strength Indication (RSSI); and
determining a priority of connectable APs of the one or more scanned APs, which are not in a full connection status, based at least in part on an AP having a higher RSSI based on the parsed AP information.

16. The method of claim 15, further comprising:
attempting a connection to the one or more scanned APs according to the determined priority.

17. The method of claim 15,
wherein the parsing of the AP information includes determining the number of terminals connected to the one or more scanned APs, and
wherein the determining of the priority of connectable APs determines priority of connection of the one or more scanned APs, which are not in a full connection status, and is based at least in part on an AP having a higher RSSI and having a smaller number of connected terminals.

18. The method of claim 15,
wherein the parsing of the AP information includes determining the number of terminals connectable to the one or more scanned APs, and
wherein the determining of the priority of connectable APs determines priority of connection of the one or more scanned APs, which are not in a full connection status, and is based at least in part on an AP having a higher RSSI and having a greater number of connectable terminals.

19. The method of claim 17,
wherein the parsing of the AP information includes determining the number of terminals connectable to the one or more scanned APs, and
wherein the determining of the priority of connectable APs determines priority of connection of the one or more scanned APs, which are not in a full connection status, and is based at least in part on an AP having a higher RSSI, having a smaller number of connected terminals and having a greater number of connectable terminals.

20. A method for performing wireless communication to determine priority of a wireless connection to an access point (AP), the method comprising:
scanning at least one AP within a receivable range of a terminal to collect air log information of the at least one AP;
determining from the collected air log information a connection status of the at least one AP in the receivable range; and
determining an order of priority to connect the terminal to the at least one AP within the receivable range, based on the determined connection status of the at least one AP.

21. The method of claim 20, further comprising:
classifying the at least one AP within the receivable range according to Received Signal Strength Indication (RSSI) included in the collected air log information;
wherein determining the order of priority further comprises:
determining a relative order of a high RSSI to a low RSSI for the at least one AP in the receivable range not in a full connection status.

22. The method of claim 20, further comprising:
determining from the collected air log information a number of terminals connected to a corresponding AP for the at least one AP in the receivable range, and
wherein determining the order of priority is further based on the determined number of terminals connected to a corresponding AP for the at least one AP not in a full connection status.

23. The method of claim 20, further comprising:
determining from the collected air log information a number of terminals connectable to a corresponding AP for the at least one AP in the receivable range, and
wherein determining the order of priority is further based on the determined number of terminals connectable to a corresponding AP for the at least one AP not in a full connection status.

24. The method of claim 23, further comprising:
determining from the collected air log information a number of terminals connected to a corresponding AP for the at least one AP in the receivable range, and
wherein determining the order of priority is further based on the determined number of terminals connected to a corresponding AP for the at least one AP not in the full connection status.

25. The method of claim 20, further comprising:
attempting connection by the terminal with the at least one AP within the receivable range based on the determined order of priority.
